(19) United States
(12) Patent Application Publication
(10) Pub. No.: US 2016/0010616 A1
(43) Pub. Date: Jan. 14, 2016

(54) IGNITION CONTROL APPARATUS FOR INTERNAL COMBUSTION ENGINE (AS AMENDED)

(71) Applicant: Koshiro KIMURA, Aichi (JP)

(72) Inventor: Koshiro KIMURA, Susono-shi, Shizuoka-ken (JP)

(73) Assignee: TOYOTA JIDOSHA KABUSHIKI KAISHA, Toyota-shi, Aichi-ken (JP)

(21) Appl. No.: 14/762,252

(22) PCT Filed: Jan. 23, 2013
(86) PCT No.: PCT/JP2013/051321

§ 371 Date: Jul. 21, 2015

(51) Int. Cl. F02P 17/12; F02P 9/00; F02P 17/02

(52) U.S. Cl. CPC F02P 17/12; F02P 17/02; F02P 9/002

(57) ABSTRACT

An ignition control apparatus for an internal combustion engine of the present invention includes a spark plug (34) for igniting an air-fuel mixture in a cylinder, and is configured to be capable of measuring a discharge voltage and a discharge current of the spark plug (34). The ignition control apparatus determines the flow velocity of an in-cylinder gas based on a discharge energy integration value that is obtained by integrating a product of the discharge voltage and the discharge current over a predetermined period.

### TECHNICAL FIELD

The present invention relates to an ignition control apparatus for an internal combustion engine.

### BACKGROUND ART

A control apparatus for a spark-ignition type internal combustion engine has already been disclosed in, for example, Patent Literature 1. The conventional control apparatus is configured to detect a secondary current (discharge current) that flows to a spark plug or a secondary voltage (discharge voltage) that is applied to the spark plug, and to determine whether or not a gas flow velocity in a cylinder is equal to or greater than a determination flow velocity, based on the detected secondary current or secondary voltage.

More specifically, the above described conventional control apparatus determines that the gas flow velocity is equal to or greater than the aforementioned determination flow velocity in a case where a discharge sustaining voltage that is a secondary voltage after a dielectric breakdown voltage has been reached is equal to or greater than a determination voltage or in a case where a secondary voltage after a predetermined period has elapsed from the generation thereof is equal to or greater than a determination voltage, hi addition, in a case where a secondary current after a predetermined period elapses from the generation thereof is less than or equal to a predetermined current, it is determined that the gas flow velocity is equal to or greater than the aforementioned determination flow velocity.

Depending on the operating state of the internal combustion engine, a phenomenon (discharge interruption) may occur in which the discharge spark of a spark plug is interrupted as a result of the flow velocity (gas flow velocity) of a gas (air-fuel mixture) that flows inside a cylinder increasing. If a discharge interruption occurs, the secondary voltage and the secondary current will change suddenly. Therefore, according to the method described in the aforementioned Patent Literature 1, there is a concern that the accuracy of determining the flow velocity of in-cylinder gas will deteriorate if a discharge interruption occurs.

The applicants are aware of the following literature, which includes the above described literature, as literature related to the present invention.

### CITATION LIST

### Patent Literature

Patent Literature 1: Japanese Patent Laid-Open No. 2009-013850

Patent Literature 2: Japanese Utility Model Laid-Open No. 63-168282

### SUMMARY OF INVENTION

The present invention has been made to address the above described problems, and an object of the present invention is to provide an ignition control apparatus for an internal combustion engine that can suppress a deterioration in the accuracy of determining a flow velocity in-cylinder gas, even in a case where a discharge interruption occurred.

The present invention is an ignition control apparatus for an internal combustion engine that includes a spark plug, discharge voltage measurement means, discharge current measurement means, and flow velocity determination means.

The spark plug is configured to ignite an in-cylinder gas. The discharge voltage. measurement means measures a discharge voltage of the spark plug. The discharge current measurement means measures a discharge current of the spark plug. The flow velocity determination means determines a flow velocity of an in-cylinder gas based on a discharge energy integration value that is obtained by integrating a product of the discharge voltage and the discharge current over a predetermined period.

The magnitude of a time-averaged flow velocity of an in-cylinder gas within a predetermined period during a discharge period is expressed as the size of a discharge energy integration value at a time point at which the predetermined period elapses, including a case in which a discharge interruption occurs. According to the present invention, by determining the flow velocity based on the discharge energy integration value, it is possible to suppress a deterioration in the accuracy of determining the flow velocity of in-cylinder gas, even in a case where a discharge interruption occurred.

The flow velocity determination means of the present invention may determine that, in a case where the discharge energy integration value is large, the flow velocity of an in-cylinder gas is high in comparison to a case where the discharge energy integration value is small.

By this means, the magnitude of the flow velocity of the in-cylinder gas can be determined based on whether the discharge energy integration value is large or small.

Further, the flow velocity determination means of the present invention may determine that, in a case where the discharge energy integration value is equal to or greater than a predetermined threshold value, the flow velocity of the in-cylinder gas is equal to or greater than a determination flow velocity value.

By this means, the magnitude of the flow velocity of the in-cylinder gas can be determined in comparison with the determination flow velocity value, based on whether the discharge energy integration value is large or small.

The present invention may further include additional energy supply means for supplying additional ignition energy in a case where the flow velocity of the in-cylinder gas that is determined by the flow velocity determination means is less than the determination flow velocity value.

By this means, in a cycle in which the determined flow velocity of the in-cylinder gas is low, by supplying additional ignition energy it is possible to prevent a deterioration in combustion in this cycle and suppress the occurrence of combustion variations.

The present invention may further include discharge interruption occurrence timing detection means for determining whether or not a time differential value of the discharge voltage exceeds a predetermined threshold value, and based on a time at which the time differential value exceeds the threshold value, detecting a discharge interruption occurrence timing at which a discharge interruption occurs at the spark plug.

By this means, a discharge interruption occurrence timing that is a timing that varies according to the operating state of the internal combustion engine can be acquired.

The present invention may also include second flow velocity determination means for determining a flow velocity of an in-cylinder gas based on a size of the discharge voltage, in which, in a case where the discharge interruption occurrence timing is earlier than a predetermined timing, the flow velocity of the in-cylinder gas is determined using the flow velocity determination means, and in a case where the discharge interruption occurrence timing is identical to or later than the predetermined timing, the flow velocity of the in-cylinder gas is determined using the second flow velocity determination means.

In comparison to the flow velocity determination means that uses a discharge energy integration value, the second flow velocity determination means that uses the size of the discharge voltage can quickly perform a flow velocity determination because the calculation load relating to the flow velocity determination is less. Accordingly, in a case where it is possible to perform a flow velocity determination based on the size of the discharge voltage without being influenced by a discharge interruption, this determination method is used. This makes it possible to shorten a delay time period from a flow velocity determination time point until the supply of additional ignition energy is performed, in a cycle in which the supply of additional ignition energy is necessary because the flow velocity at the time of spark is low. By this means, it is possible to more reliably suppress a deterioration in combustion in that cycle.

### BRIEF DESCRIPTION OF DRAWINGS

FIG. 1 is a schematic view for describing the system configuration of an internal combustion engine according to Embodiment 1 of the present invention.

FIG. 2 is a schematic view illustrating the configuration of an ignition device shown in FIG. 1.

FIG. 3 is a view illustrating an example of time waveforms of a discharge voltage in a case where a discharge interruption occurs.

FIG. 4 is a view that schematically illustrates an example of time waveforms of a discharge energy integration value used for determining a flow velocity of in-cylinder gas in Embodiment 1 of the present invention.

FIG. 5 is a view for describing characteristic ignition control in Embodiment 1 of the present invention.

FIG. 6 is a flowchart of a routine that is executed in Embodiment 1 of the present invention in order to determine the flow velocity of in-cylinder gas and implement ignition control.

FIG. 7 is a multiple view drawing for describing a method for detecting a discharge interruption occurrence timing according to Embodiment 2 of the present invention.

FIG. 8 is a flowchart of a routine that is executed in Embodiment 2 of the present invention to acquire a discharge interruption occurrence timing.

FIG. 9 is a flowchart of a routine that is executed in Embodiment 2 of the present invention to switch a flow velocity determination method in accordance with a discharge interruption occurrence timing.

### DESCRIPTION OF EMBODIMENTS

### Embodiment 1

### Description of System Configuration

### (Configuration of Internal Combustion Engine)

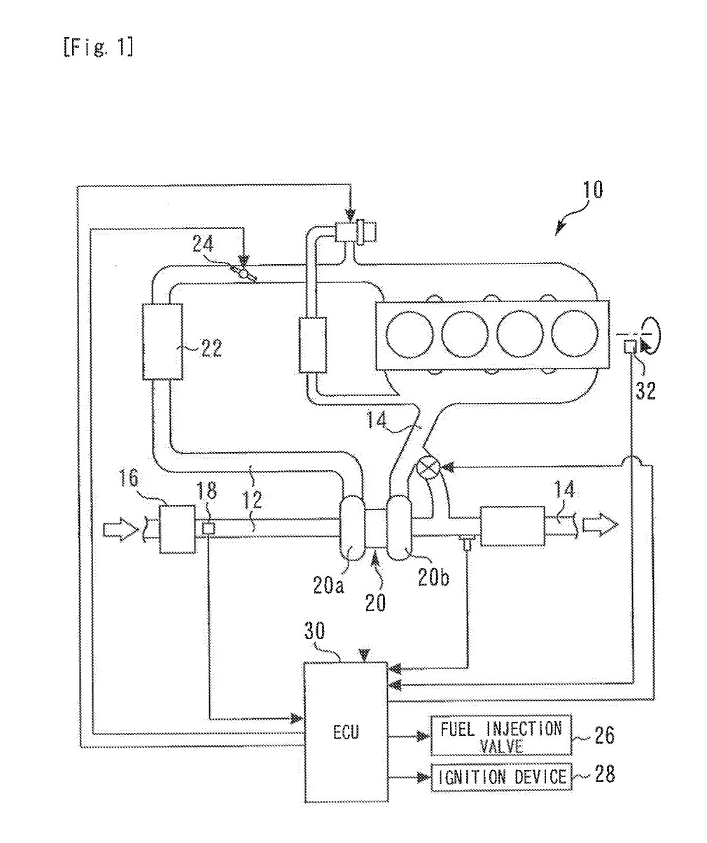

FIG. 1 is a schematic view for describing the system configuration of an internal combustion engine 10 of Embodiment 1 of the present invention. A system of the present embodiment includes a spark ignition-type internal combustion engine (in this case, as one example, it is assumed that the engine is a gasoline engine) 10. An intake passage 12 and an exhaust passage 14 communicate with each cylinder of the internal combustion engine 10.

An air cleaner 16 is installed in the vicinity of an inlet of the intake passage 12. An air flow meter 18 that outputs a signal in accordance with a flow velocity of air that is drawn into the intake passage 12 is provided in the vicinity of the air cleaner 16 on a downstream side thereof. A compressor 20a of a turbo-supercharger 20 is arranged downstream of the air flow meter 18.

The compressor 20a is integrally connected through a connecting shaft with a turbine 20b arranged in the exhaust passage 14. An intercooler 22 that cools compressed air is provided on a downstream side of the compressor 20a. An electronically controlled throttle valve 24 is provided downstream of the intercooler 22.

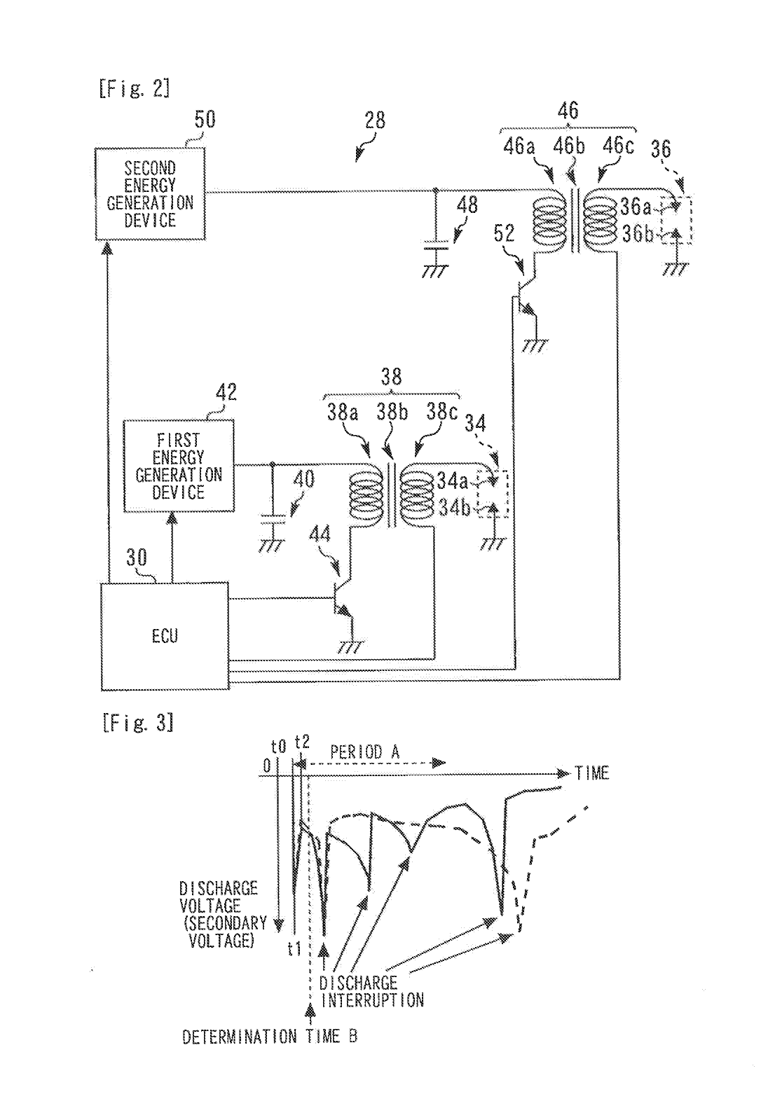

Each cylinder of the internal combustion engine 10 is provided with a fuel injection valve 26 for injecting fuel directly into the cylinder. The internal combustion engine 10 is also equipped with an ignition device 28 that includes a first spark plug 34 and a second spark plug 36 (see FIG. 2) for igniting an in-cylinder gas (air-fuel mixture) in each cylinder. An example of the specific configuration of the ignition device 28 is described later referring to FIG. 2.

The system illustrated in FIG. 1 further includes an ECU (electronic control unit) 30. In addition to the aforementioned air now meter 18, various sensors for detecting the operating state of the internal combustion engine 10, such as a crank angle sensor 32 for detecting an engine speed, are connected to an input portion of the ECU 30. Various actuators for controlling operation of the internal combustion engine 10, such as the aforementioned throttle valve 24, fuel injection valve 26 and ignition device 28, are connected to an output portion of the ECU 30. The ECU 30 performs predetermined engine control such as fuel injection control and ignition control by actuating the various actuators in accordance with the output of the various sensors described above and predetermined programs.

### (Configuration of Ignition Device)

FIG. 2 is a schematic view illustrating the configuration of the ignition device 28 shown in FIG. 1.

The ignition device 28 includes two spark plugs, namely, the first spark plug 34 and the second spark plug 36, for each cylinder of the internal combustion engine 10. The first spark plug 34 is mounted at a center portion of a ceiling wall of a combustion chamber. The second spark plug 36 is mounted at an edge portion of the ceiling wall. During operation of the internal combustion engine 10, the first spark plug 34 is used as a principal spark plug, and the second spark plug 36 is used in an auxiliary manner as required.

As shown in FIG. 2, for the first spark plug 34, the ignition device 28 includes a first ignition coil 38, a first capacitor 40, a first energy generation device 42 and a first transistor 44. Similarly, for the second spark plug 36, the ignition device 28 includes a second ignition coil 46, a second capacitor 48, a second energy generation device 50 and a second transistor 52.

The first spark plug 34 has a center electrode 34a and a ground electrode 34b that are arranged so as to protrude into the cylinder from the center portion of the ceiling wall. The first ignition coil 38 has a primary coil 38a and a secondary coil 38c, The secondary coil 38c shares an iron core 38b with the primary coil 38a. The center electrode 34a is connected to one end of the secondary coil 38c. The ground electrode 34b is grounded to a cylinder head. The other end of the secondary coil 38c is connected to the ECU 30.

The first capacitor 40 is provided for storing electrical energy of a primary current that circulates through the primary coil 38a. One end of the first capacitor 40 is connected to one end of the primary coil 38a and the first energy generation device 42, and the other end thereof is grounded.

The first energy generation device 42 includes a power source, and supplies electrical energy to the first capacitor 40 in accordance with a command from the ECU 30. It is thereby possible to store (charge) a predetermined electrical charge in the first capacitor 40.

A collector of the first transistor 44 is connected to the other end of the primary coil 38a, a base thereof is connected to the ECU 30, and an emitter thereof is grounded. In the first transistor 44, the section between the collector and the emitter enters a short-circuit state (“on state”) when a signal current flows to the emitter from the base in accordance with control by the ECU 30. It is thereby possible to feed a primary current to the primary coil 38a. Thus, by controlling the first transistor 44, the ECU 30 can control feeding and interruption of a primary current that flows to the primary coil 38a.

If the primary current to the primary coil 38a is interrupted, a high secondary voltage is generated in the secondary coil 38c by a mutual inductive action. The generated secondary voltage is applied to the first spark plug 34. When the secondary voltage applied from the secondary coil 38c reaches a value (required voltage) that is necessary for dielectric breakdown between the center electrode 34a and the ground electrode 34b, a current flows between the electrodes 34a and 34b (that is, an electrical discharge occurs), and a spark (electric spark) is generated in a gap between the electrodes 34a and 34b (a so-called “spark gap”).

The contents of the specific configuration (that is, the second ignition coil 46, the second capacitor 48, the second energy generation device 50 and the second transistor 52) for causing a secondary voltage to be applied between the center electrode 36a and the ground electrode 36b of the second spark plug 36 are the same as the above described contents of the configuration of the first spark plug 34, and therefore a detailed description thereof is omitted.

According to the ignition device 28 described above, a spark timing and a discharge duration of the spark plugs 34 and 36 can be controlled by the ECU 30 which controls the energy generation devices 42 and 50 and the transistors 44 and 52. Further, the ECU 30 is configured to be capable of measuring the secondary voltage (discharge voltage) of the secondary coil 38c that is applied to the first spark plug 34, using a voltage probe that is not illustrated in the drawings (the same also applies with respect to the second spark plug 36 side). In addition, the ECU 30 is configured to be capable of measuring a secondary current (discharge current) of the secondary coil 38c that flows to the first spark plug 34, using an electric current probe that is not illustrated in the drawings (the same also applies with respect to the second spark plug 36 side).

### Problem when Utilizing Discharge Voltage of Spark Plug to Determine Flow Velocity of In-Cylinder Gas

When the flow velocity of gas (air-fuel mixture) in the vicinity of the electrodes 34a and 34b of the first spark plug 34 changes, the path length of a spark discharge changes. More specifically, when the flow velocity of the in-cylinder gas increases, the spark is carried by the flow and the discharge path lengthens. When the discharge path lengthens, the electrical resistance between the center electrode 34a and the ground electrode 34b increases. As a result, the secondary voltage that is required for sustaining the discharge increases as the flow velocity of the gas that flows inside the cylinder increases. Accordingly, it is possible to estimate the flow velocity of gas that flows in the vicinity of the first spark plug 34, based on the discharge voltage (secondary voltage) that is applied to the first spark plug 34.

FIG. 3 is a view illustrating an example of time waveforms of a discharge voltage in a case where a discharge interruption occurs.

A time point t0 in FIG. 3 corresponds to a timing at which a secondary voltage starts to be applied to the first spark plug 34 accompanying interruption of the primary current flowing through the primary coil 38a of the first ignition coil 38 by control of the first transistor 44 performed by the ECU 30. A time point t1 thereafter corresponds to a timing at which the secondary voltage applied to the first spark plug 34 reaches a voltage (required voltage) that is necessary for dielectric breakdown. A spark arises between the electrodes 34a and 34b at the time point t1, and discharge is started.

The discharge is divided into two forms. The initial discharge is caused by the release of electrical energy that was stored in the first capacitor 40 (so-called “capacitive discharge”). The duration of the capacitive discharge corresponds to what is actually an extremely short time period from the time point t1 to a time point t2. The discharge after the capacitive discharge ends (that is, after the time point t2) is caused by the release of electromagnetic energy that was stored in the secondary coil 38c (so-called “inductive discharge”). Note that, as shown in FIG. 3, since the discharge voltage waveform exhibits a conspicuous inflection point at the timing at which the inductive discharge starts (time point t2), the timing at which the inductive discharge starts can be ascertained by determining such an inflection point.

A “period A” shown in FIG. 3 is a period in which the flow velocity of the in-cylinder gas influences ignition of the in-cylinder gas. This period A is a predetermined discharge period from the time point at which discharge starts, and varies according to the operating conditions and the specifications of the ignition system. A waveform shown by a solid line in FIG. 3 represents a time waveform of a discharge voltage in a cycle in which a time-averaged value of a flow velocity (hereunder, may be referred to as “time-averaged flow velocity”) of the in-cylinder gas during the aforementioned predetermined period (for example, the period A) is large (that is, a cycle in which the flow velocity during the predetermined period is continuously high). On the other hand, a waveform shown by a broken line in FIG. 3 represents a time waveform of a discharge voltage in a cycle in which the time-averaged flow velocity of the in-cylinder gas during the aforementioned predetermined period is small (that is, a cycle in which the flow velocity is high at an initial stage of the predetermined period but decreases partway through the predetermined period).

Depending on the operating state of the internal combustion engine 10, a phenomenon (discharge interruption) may occur in which the spark discharge of the spark plug 34 is interrupted as a result of the flow velocity (gas flow velocity) of the gas that flows inside the cylinder increasing. In particular, at a time of lean-burn operation, the electrical resistance in the discharge path increases since the air-fuel ratio is large, and therefore a discharge interruption is more liable to occur.

When a discharge interruption occurs, the discharge voltage changes suddenly as shown in FIG. 3. More specifically, immediately before a discharge interruption occurs, a sharp rise in the voltage occurs because the electrical resistance increases in the discharge path. Subsequently, a sharp drop in the voltage occurs due to a re-discharge that is performed thereafter. Accordingly, at a time that a discharge interruption occurs and from that time onwards, it is difficult to accurately determine the flow velocity of the in-cylinder gas based on the size of the discharge voltage. For example, immediately after the occurrence of a discharge interruption, even though the flow velocity of in-cylinder gas should still be high, if a flow velocity determination is performed based on the size of the discharge voltage that rapidly dropped, the accuracy of the determination will deteriorate.

Further, when the engine is operating at a high engine speed, a discharge interruption is liable to occur at an early stage after discharge starts because the flow velocity of the in-cylinder gas will be high at the time of spark. Therefore, in a case where it is attempted to determine the flow velocity of in-cylinder gas based on the size of the discharge voltage, when the engine is operating at a high engine speed also, it is necessary to determine the flow velocity at an early stage after discharge starts which is a stage in which a discharge interruption definitely does not occur. However, as indicated by “determination time B” in FIG. 3, if it is attempted to determine the flow velocity based on the size of the discharge voltage at a timing that is too early in an initial stage after discharge starts, there is a concern that the accuracy of estimating the flow velocity will deteriorate. This is because changes in the flow velocity of an in-cylinder gas during a discharge period cannot be ascertained only by determining the size of a discharge voltage in an initial stage after discharge starts, and as a result, as shown in FIG. 3, there is a possibility that a distinction will fail to be made between the cycle (solid line) in which the time-averaged flow velocity is large in the aforementioned period A and a cycle (dashed line) in which the time-averaged flow velocity is small.

### Characteristic Method for Determining Flow Velocity of In-Cylinder Gas in Embodiment 1

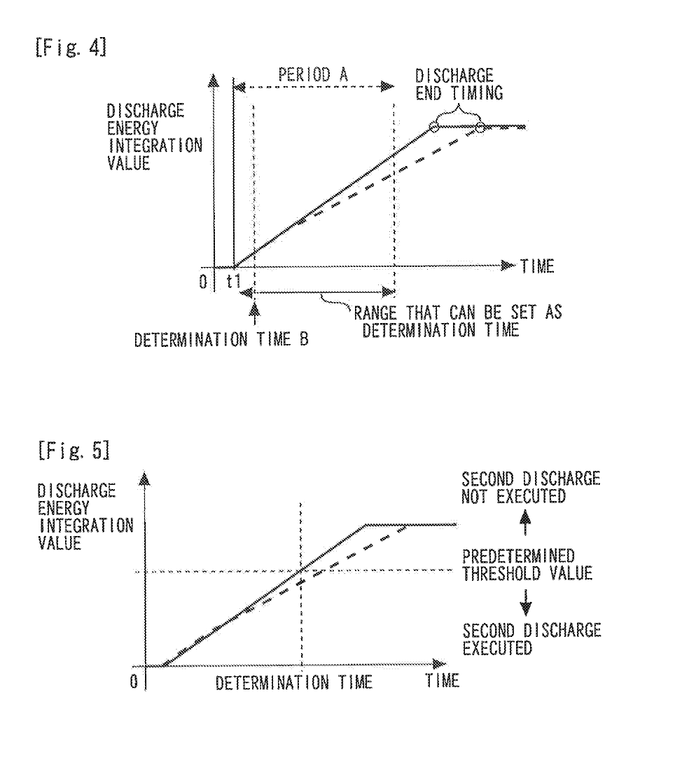

FIG. 4 is a view that schematically illustrates an example of time waveforms of a discharge energy integration value used for determining a flow velocity of in-cylinder gas in Embodiment 1 of the present invention. Note that, the two waveforms represented by a solid line and a dashed line in FIG. 4 correspond to the two waveforms represented by a solid line and a dashed line in FIG. 3, respectively.

In the present embodiment, a configuration is adopted that determines the flow velocity of a gas that flows inside a cylinder based on the size of a value (hereunder, referred to as “discharge energy integration value”) that is calculated by integrating the product of a discharge voltage (secondary voltage) and a discharge current (secondary current) over a predetermined period (for example, the aforementioned period A) during a discharge period. More specifically, in the present embodiment, a configuration is adopted that, in a case where the calculated discharge energy integration value is large, determines that the flow velocity of the in-cylinder gas is high in comparison to a case where the calculated discharge energy integration value is small.

The magnitude of a time-averaged flow velocity of an in-cylinder gas within a predetermined period during a discharge period is expressed as the size of a discharge energy integration value at a time point at which the predetermined period elapses. The reason for this is as follows. That is, in a cycle in which the time-averaged flow velocity is large in a period from the start of discharge until the end of the discharge, even in a case where a discharge interruption occurs, the average path length of the discharge path lengthens and, as a result, a time-averaged value of the electrical resistance in the discharge path increases. In accompaniment therewith, a time constant τ(=L/R) of an RL series circuit on the secondary side (circuit for which the secondary coil 38c is regarded as a coil L and the resistance between the electrodes 34a and 34b is regarded as a resistance R) after discharge starts becomes relatively smaller. Consequently, as shown in FIG. 4, in a cycle in which the time-averaged flow velocity is large, the time at which the discharge ends is earlier, regardless of whether or not a discharge interruption occurs. Conversely, in a cycle which the time-averaged flow velocity is small, a time-averaged value of the electrical resistance in the discharge path decreases. In accompaniment therewith, as shown in FIG. 4, since the time constant becomes relatively larger, the time at which discharge ends is later. That is, as the time-averaged flow velocity is higher, a slope (time rate of change) of the discharge energy integration value with respect to the time period becomes higher.

As described above, it is possible to determine whether the flow velocity of in-cylinder gas is high or low based on the size of the discharge energy integration value. Therefore, in the present embodiment, in a case where the discharge energy integration value is equal to or greater than a predetermined threshold value, it is determined that the flow velocity of the in-cylinder gas is equal to or greater than a determination flow velocity value. A configuration may also be adopted in which, instead of the aforementioned determination, the larger that the discharge energy integration value is, the higher that the flow velocity of the in-cylinder gas is determined as being.

Further, by using the discharge energy integration value that is obtained by time-integrating the discharge voltage and the discharge current over a predetermined period, a configuration can be realized in which an abrupt change in the discharge voltage that accompanies a discharge interruption does not influence a flow velocity determination with respect to the in-cylinder gas. Consequently, as shown in FIG. 4, a range within which it is possible to set a determination time with respect to the flow velocity of in-cylinder gas can be widened. By this means, since it is no longer necessary to set a determination time to a time that is too early, such as the determination time B, in order to take into account the influence of a discharge interruption as described above, a cycle in which the time-averaged flow velocity is large and a cycle in which the time-averaged flow velocity is small can be accurately distinguished.

### Characteristic Ignition Control in Embodiment 1

FIG. 5 is a view for describing characteristic ignition control in Embodiment 1 of the present invention.

In the present embodiment, when using the above described method for determining the flow velocity of in-cylinder gas, if it is determined that the flow velocity of the in-cylinder gas is less than the determination flow velocity value because the discharge energy integration value is less than the aforementioned threshold value, a second discharge (re-discharge) by the first spark plug 34 is performed after the end of the discharge (inductive discharge) by the first spark plug 34 in the current cycle.

According to the above described ignition control, by performing a second discharge in a cycle in which there is a concern that combustion will deteriorate because the flow velocity of the in-cylinder gas is low at the time of spark, it is possible to prevent a situation from arising in which the combustion actually deteriorates in that cycle. By this means, combustion variations can be suppressed.

### Specific Processing in Embodiment 1

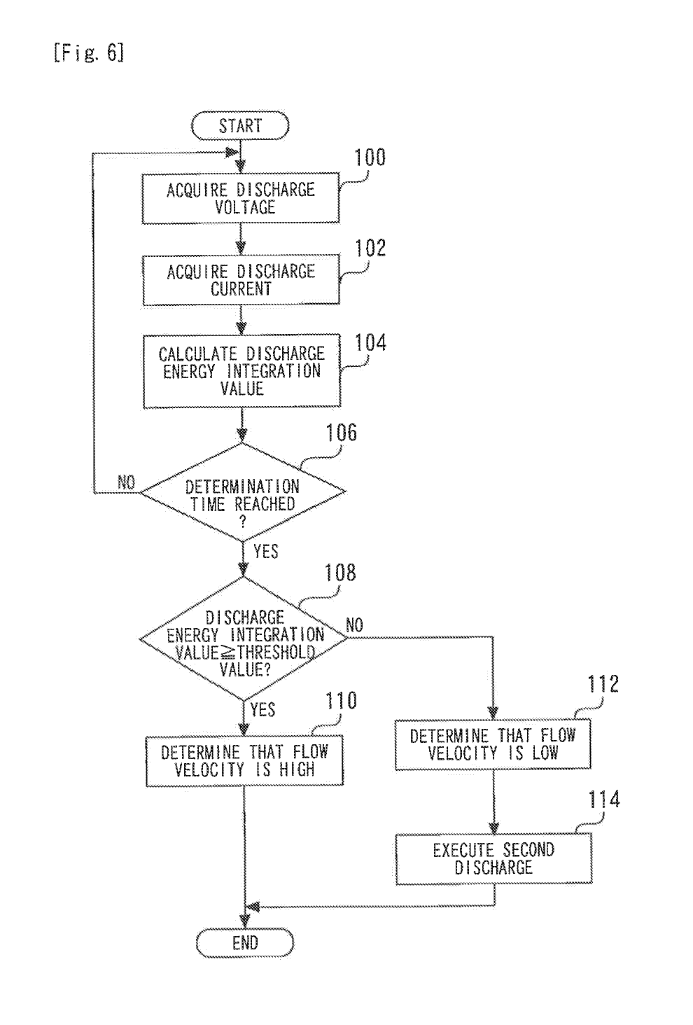

FIG. 6 is a flowchart illustrating a control routine that the ECU 30 executes to realize the characteristic flow velocity determination with respect to the in-cylinder gas and ignition control in Embodiment 1 that is described above. Note that it is assumed that the present routine is started at a timing at which a predetermined spark timing is reached in each cylinder and is repeatedly executed for each predetermined control period.

According to the routine shown in FIG. 6, first the ECU 30 executes processing to acquire a discharge voltage (secondary voltage) of the first spark plug 34 (step 100), and then executes processing to acquire a discharge current (secondary current) of the first spark plug 34 (step 102).

Next, using the acquired discharge voltage and discharge current, the ECU 30 calculates a discharge energy integration value by time-integrating the (record of) products of the discharge voltage and the discharge current from the time point at which the discharge started (step 104). Subsequently, the ECU 30 determines whether or not a predetermined determination time at which to determine the flow velocity of the in-cylinder gas (for example, the endpoint of period A shown in FIG. 4) has been reached (step 106). Calculation of the discharge energy integration value in step 104 is repeatedly executed until it is determined in step 106 that the predetermined determination time has been reached.

When it is determined in the aforementioned step 106 that the predetermined determination time has been reached, the ECU 30 then determines whether or not the discharge energy integration value at the time point at which the aforementioned determination time was reached is equal to or greater than a predetermined threshold value (step 108), If it is determined as a result that the discharge energy integration value is equal to or greater than the aforementioned threshold value, the ECU 30 determines that the flow velocity of the in-cylinder gas at the time of spark in the current cycle is equal to or greater than a predetermined determination flow velocity value (step 110).

In contrast, if it is determined in the aforementioned step 108 that the discharge energy integration value is less than the aforementioned threshold value, the ECU 30 determines that the flow velocity of the in-cylinder gas at the time of spark in the current cycle is less than the aforementioned determination flow velocity value (step 112). In this case, next, the ECU 30 controls the first energy generation device 42 and the first transistor 44 so that a second discharge (re-discharge) by the first spark plug 34 is performed after the end of the inductive discharge by the first spark plug 34 (step 114). Such control can be performed, for example, by charging the first capacitor 40 after the first discharge is performed by the first spark plug 34, and thereafter by circulating and interrupting a primary current. Alternatively, such control may be implemented, for example, by adopting a configuration in which a plurality of ignition coils are provided for the first spark plug 34, and after the first discharge is performed, by performing discharge utilizing an unused other ignition coil.

According to the method of determining the flow velocity of in-cylinder gas of the present embodiment that is described above, it is possible to accurately distinguish high and low values of the flow velocity of the in-cylinder gas even in a case where a discharge interruption occurs during a predetermined period in which the flow velocity determination is performed. Further, according to the ignition control of the present embodiment, in a case where the determined flow velocity of the in-cylinder gas is low, a deterioration in combustion in the cycle can be prevented by performing a second discharge during the same cycle, and thus the occurrence of combustion variations can be suppressed.

In the above described Embodiment 1 a configuration is adopted that performs a second discharge using the first spark plug 34 when it is determined that, based on the size of the discharge energy integration value, the flow velocity of the in-cylinder gas is less than the aforementioned determination flow velocity value. However, additional energy supply means in the present invention is not limited to means for supplying additional ignition energy by a second discharge as described above, and for example a configuration may be adopted that uses the following technique. That is, a configuration may be adopted that controls the second energy generation device 50 and the second transistor 52 so that, after a first discharge by the first spark plug 34, the unused second spark plug 36 is used to execute a second discharge during the combustion period.

Note that, in the above described Embodiment 1, the “discharge voltage measurement means” in the present invention is realized by the ECU 30 executing the above described processing in step 100, the “discharge current measurement means” in the present invention is realized by the ECU 30 executing the above described processing in step 102, and the “flow velocity measurement means” in the present invention is realized by the ECU 30 executing the series of processing in steps 104 to 112.

Further, in the above described Embodiment 1, the “additional energy supply means” in the present invention is realized by the ECU 30 executing the above described processing in step 114 in a case where the result determined in step 108 is not affirmative.

### Embodiment 2

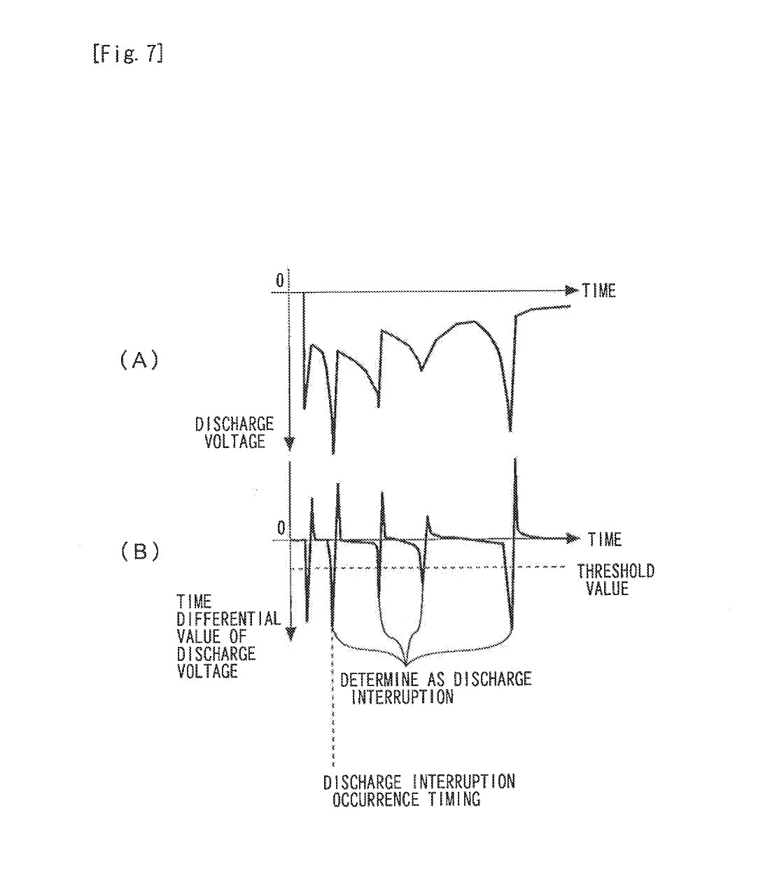

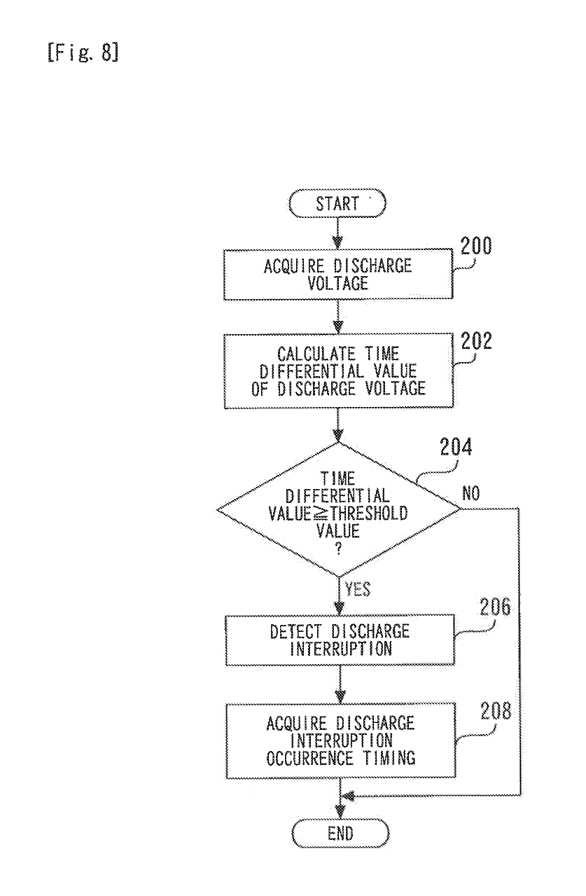

Next, Embodiment 2 of the present invention will be described referring to FIG. 7 and FIG. 8.

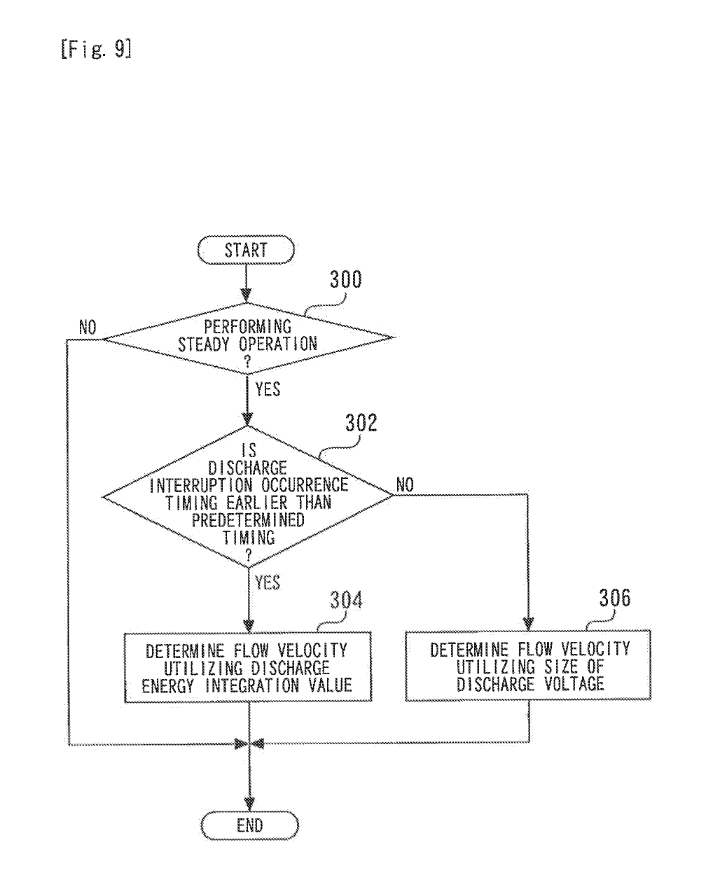

The system of the present embodiment can be realized by using the hardware configuration illustrated in FIG. 1 and FIG. 2, and causing the ECU 30 to execute the routines shown in FIG. 8 and FIG. 9, described later, together with the routine shown in FIG. 6.

### Characteristic Portion of Embodiment 2

FIG. 7 is a multiple view drawing for describing a method for detecting a discharge interruption occurrence timing in Embodiment 2 of the present invention. More specifically, FIG. 7(A) illustrates an example of a discharge voltage waveform at a time of spark by the first spark plug 34, and FIG. 7(B) illustrates a waveform of a time differential value (rate of change) of the discharge voltage shown in FIG. 7(A).

As described above, a discharge voltage increases rapidly immediately before a discharge interruption occurs. Therefore, in the present embodiment a configuration is adopted that determines whether or not a time differential value of the discharge voltage exceeds a predetermined threshold value, and detects a discharge interruption occurrence timing (the basis of which is a discharge starting time point) at which a discharge interruption (an initial discharge interruption) occurs at the first spark plug 34 based on a time at which the time differential value exceeds the threshold value.

In addition, in the present embodiment, at a time that the operating state of the internal combustion engine 10 is a substantially steady operating state, it is determined whether or not the discharge interruption occurrence timing is earlier than a predetermined timing. If it is determined that the discharge interruption occurrence timing is earlier than the predetermined timing, the flow velocity of the in-cylinder gas is determined using the method of Embodiment 1 utilizing the discharge energy integration value that is described above, while if it is determined that the discharge interruption occurrence timing is identical to or later than the predetermined timing, the flow velocity of the in-cylinder gas is determined based on the size of the discharge voltage.

### Specific Processing in Embodiment 2

FIG. 8 is a flowchart illustrating a routine that the ECU 30 executes in Embodiment 2 to acquire a discharge interruption occurrence timing. Note that it is assumed that the present routine is started at a timing at which a predetermined spark timing is reached in each cylinder, and is repeatedly executed for each predetermined control period.

According to the routine illustrated in FIG. 8, first the ECU 30 executes processing to acquire a discharge voltage (secondary voltage) of the first spark plug 34 (step 200). Next, the ECU 30 calculates a time differential value of the discharge voltage using a current value and a previous value of the discharge voltage (step 202).

Thereafter, the ECU 30 determines whether or not the calculated time differential value of the discharge voltage is greater than a predetermined threshold value (step 204), if the result determined is that the time differential value of the discharge voltage is greater than the aforementioned threshold value, the ECU 30 detects the occurrence of a discharge interruption at the time at which the current time differential value was calculated (step 206), and stores a discharge interruption occurrence timing as a value that is based on the discharge starting time point in association with the current operating state (step 208).

The discharge interruption occurrence timing varies depending on the operating state of the internal combustion engine 10. According to the routine illustrated in FIG. 8 that is described above, the actual discharge interruption occurrence timing in the current operating state can be acquired.

FIG. 9 is a flowchart illustrating a routine that the ECU 30 executes in Embodiment 2 to switch the flow velocity determination method in accordance with the discharge interruption occurrence timing. Note that it is assumed that the present routine is repeatedly executed for each predetermined control period in parallel with the routine illustrated in FIG. 8 that is described above.

According to the routine illustrated in FIG. 9, first, the ECU 30 utilizes the output of the air flow meter 18 and the crank angle sensor 32 and the like to determine whether or not the current operating state of the internal combustion engine 10 is a substantially steady operating state (step 300).

If it is determined in the aforementioned step 300 that the current operating state of the internal combustion engine 10 is a substantially steady operating state, next, the ECU 30 determines whether or not the discharge interruption occurrence timing in the current operating state is earlier than a predetermined timing (step 302). The predetermined timing in the present step 302 is a value that is previously set as a threshold value for enabling a determination with respect to whether or not there is some margin in which a flow velocity determination can be performed based on the size of the discharge voltage during the period of time until the discharge interruption occurrence timing is reached, and is a value that is set in accordance with the operating conditions.

If it is determined in the above described step 302 that the discharge interruption occurrence timing is earlier than the aforementioned predetermined timing, a method that utilizes the aforementioned discharge energy integration value that is described above in Embodiment I is selected as the flow velocity determination method to be used in the current operating state (step 304). On the other hand, if it is determined in the above described step 302 that the discharge interruption occurrence timing is identical to or later than the aforementioned predetermined timing, a flow velocity determination method that is based on the size of the discharge voltage is selected as the flow velocity determination method to be used in the current operating state (step 306). More specifically, according to the flow velocity determination method in the present step 306, if the discharge voltage at a predetermined timing (the determination timing B in FIG. 3 corresponds thereto) during the discharge period (inductive discharge period) is equal to or greater than a predetermined value, it is determined that the flow velocity of the in-cylinder gas is equal to or greater than a predetermined determination flow velocity value.

According to the routine illustrated in FIG. 9 that is described above, the flow velocity determination method is switched in accordance with the discharge interruption occurrence timing, In comparison to the flow velocity determination method that uses a discharge energy integration value, the flow velocity determination method that is based on the size of the discharge voltage can quickly perform a flow velocity determination since the calculation load that is applied to the ECU 30 and the like is less. Accordingly, when it is possible to perform a flow velocity determination based on the size of the discharge voltage without receiving the influence of a discharge interruption, this determination method is used. This makes it possible to shorten a delay time period from a flow velocity determination time point until a second discharge is performed, in a cycle in which a second discharge is required because the flow velocity at the time of spark is low. By this means, it is possible to more reliably suppress a deterioration in combustion in that cycle.

Note that, in the above described Embodiment 2, the “discharge interruption occurrence timing detection means” in the present invention is realized by the ECU 30 executing the series of processing in steps 200 to 208.

Further, in the above described Embodiment 2, the “second flow velocity determination means” in the present invention is realized by the ECU 30 executing the above described processing in step 306.

### DESCRIPTION OF SYMBOLS

10 Internal combustion engine
12 Intake passage
14 Exhaust passage
16 Air cleaner
18 Air flow meter
20 Turbo-supercharger
22 Intercooler
24 Throttle valve
26 Fuel injection valve
28 Ignition device
30 ECU (electronic control unit)
32 Crank angle sensor
34 First spark plug
34a Center electrode of first spark plug
34b Ground electrode of first spark plug
36 Second spark plug
36a Center electrode of second spark plug
36b Ground electrode of second spark plug
38 First ignition coil
38a Primary coil of first ignition coil
38b Iron core of first ignition coil
38c Secondary coil of first ignition coil
40 First capacitor
42 First energy generation device
44 First transistor
46 Second ignition coil
48 Second capacitor
50 Second energy generation device
52 Second transistor

1. An ignition control apparatus for an internal combustion engine, comprising:
a spark plug configured to ignite an in-cylinder gas; and
an electronic control unit, the electronic control unit programmed to:
measure a discharge voltage of the spark plug;
measure a discharge current of the spark plug; and
determine a flow velocity of an in-cylinder gas based on a discharge energy integration value that is obtained by integrating a product of the discharge voltage and the discharge current over a predetermined period.

2. The ignition control apparatus for an internal combustion engine according to claim 1,
wherein, in a case where the discharge energy integration value is large, the ECU determines that the flow velocity of an in-cylinder gas is high in comparison to a case where the discharge energy integration value is small.

3. The ignition control apparatus for an internal combustion engine according to claim 1,
wherein, in a case where the discharge energy integration value is equal to or greater than a predetermined threshold value, ECU determines that the flow velocity of an in-cylinder gas is equal to or greater than a determination flow velocity value.

4. The ignition control apparatus for an internal combustion engine according to claim 3,
wherein the ECU is programmed to supply an additional ignition energy in a case where the flow velocity of an in-cylinder gas that is determined by the ECU is less than the determination flow velocity value.

5. The ignition control apparatus for an internal combustion engine according to claim 1,
wherein the ECU is programmed to determine whether or not a time differential value of the discharge voltage exceeds a predetermined threshold value, and based on a time at which the time differential value exceeds the threshold value, detect a discharge interruption occurrence timing at which a discharge interruption occurs at the spark plug.

6. The ignition control apparatus for an internal combustion engine according to claim 5,
wherein the ECU is further programmed to be capable of determining the flow velocity of an in-cylinder gas based on a size of the discharge voltage, and
wherein the ECU determines the flow velocity of the in-cylinder gas based on the discharge energy integration value in a case where the discharge interruption occurrence timing is earlier than a predetermined timing, while determining the flow velocity of the in-cylinder gas based on the size of the discharge voltage in a case where the discharge interruption occurrence timing is identical to or later than the predetermined timing.
